(19) United States
(12) Patent Application Publication
(10) Pub. No.: US 2026/0336186 A1
(43) Pub. Date: Oct. 29, 2026

(54) PROCESS TO PRODUCE IONOMERS

(71) Applicant: Dow Global Technologies LLC, Midland, MI (US)

(72) Inventors: Santosh S. Bawiskar, Sugar Land, TX (US); Xiaofei Sun, Houston, TX (US); Norma K. Langdon, Houston, TX (US); Matthew J. Perry, Richmond, TX (US)

(73) Assignee: Dow Global Technologies LLC, Midland, MI (US)

(21) Appl. No.: 19/116,032

(22) PCT Filed: Sep. 28, 2023
(86) PCT No.: PCT/US2023/075330

§ 371 Date: Mar. 27, 2025

Related U.S. Application Data
(60) Provisional application No. 63/411,713, filed on Sep. 30, 2022.

(51) Int. Cl. B29C 48/00; B29C 48/41; B29C 48/76; B29C 48/80; B29K 33/00; B29K 105/00; B29K 505/00

(52) U.S. Cl. CPC B29C 48/023; B29C 48/41; B29C 48/767; B29C 48/802; B29K 2033/08; B29K 2105/0085; B29K 2505/00; B29K 2995/0026

(57) ABSTRACT

A method for producing an ionomer using a counter-rotating twin screw extruder includes feeding one or more metal cations and an ethylene acid interpolymer into the counter-rotating twin screw extruder, the ethylene acid interpolymer including the polymerized reaction product of ethylene and unsaturated carboxylic acid; and producing the ionomer by at least partially neutralizing the ethylene acid interpolymer with the one or more metal cations while twin screws of the counter-rotating twin screw extruder rotate opposite each other, and wherein: the twin screws have a length to diameter ratio of at least 60; a normalized production rate of the twin screw extruder is from 0.0014 lb/hr per mm³ to 0.0037 lb/hr per mm³; the ethylene acid interpolymer has a melt index (I₂) of at least 50 dg/min, and the ionomer has a melt index of less than 20 dg/min.

### CROSS REFERENCE TO RELATED APPLICATIONS

This application claims benefit of priority under 35 U.S.C. § 119 to U.S. Application No. 63/411,713, filed Sep. 30, 2022, which is hereby incorporated by reference herein in its entirety.

### FIELD

The present invention relates to a new process for producing polymeric ionomer compositions having improved properties. More particularly, it relates to methods of producing an ionomer using a counter-rotating twin screw extruder.

### BACKGROUND

Ionomers, and methods to produce them, are well known in the art. Some ionomers may be formed by a neutralization or saponification reaction of an interpolymer with metallic ions to form metal salts on at least some of the interpolymers. These neutralization or saponification reactions may occur in reactive extrusion processes. Such produced ionomers can be used in premium applications including but not limited to film tie layers, heat seal layers, golf ball and bowling pin covers, car bumper guards, side molding strips, shoe parts, packaging films, coatings, adhesives, and for impact modifications.

### SUMMARY

However, some ion sources used to produce ionomers may have a slow reaction time. Two complications resulting from the slow reaction time are a high melt index and high haze, of which both may be indicative of an incomplete reaction. Incomplete reactions then may result in the ionomer not obtaining the desired properties for applicability in later processes.

Accordingly, methods of producing ionomers are desired that can efficiently complete the reaction and obtain the final desired properties, and thereby lower melt index and minimize haze. One potential solution to increase the completeness of ionomer reactions is to increase the residence time at an elevated melt temperature in which the interpolymer and metallic ions are in contact with each other. Thereby, the chemical reactions may be given more time to run to completion and form the desired ionomer. Two contemplated solutions along these lines are to decrease the production rate of the extruder, or to increase the length to outer diameter ratio of the extruder. However, decreasing the production rate may not be a suitable solution because it adversely affects the economics of the production of the ionomer. In commercial-scale automated production of the ionomers, this may become an untenable limitation as it may increase the cost per pound of ionomer formed. Batch mixing may not be a suitable solution for similar reasons. Particularly, batch mixers may not be suitable for continuous or automated production, again an untenable limitation.

Accordingly, methods of producing ionomers are desired that minimize haziness while achieving complete reaction (as indicated by melt index reduction), without reducing the production rate of the ionomers. Consequently, methods herein produce ionomers in a reactive extrusion process while obtaining the aforementioned desired results. Methods herein accomplish the previous by utilizing a counter-rotating twin screw extruder. Counter-rotating twin screw extruders may be designed with larger length to outer diameter ratios (hereinafter “L/D” ratios) of the screws, thereby increasing heat transfer between the interpolymers and the metallic ions, as well as allowing a longer residence time at the same rate. The improved heat transfer accelerates the reaction kinetics and increases melt temperatures of the extrusion process, thereby completing more of the ionomer generating chemical reaction and reducing haziness and melt index. The counter-rotating twin screw extruders may also be tangentially oriented, which may make the twin screws compatible with even greater L/D ratios.

According to one embodiment, a method for producing an ionomer using a counter-rotating twin screw extruder includes feeding one or more metal cations and an ethylene acid interpolymer into the counter-rotating twin screw extruder, the ethylene acid interpolymer including the polymerized reaction product of ethylene and unsaturated carboxylic acid; and producing the ionomer by at least partially neutralizing the ethylene acid interpolymer with the one or more metal cations while twin screws of the counter-rotating twin screw extruder rotate opposite each other, and wherein: the twin screws have a length to diameter ratio of at least 60; a normalized production rate of the twin screw extruder is from 0.0014 lb/hr per mm³ to 0.0037 lb/hr per mm³; the ethylene acid interpolymer has a melt index (I₂) of at least 50 dg/min, and the ionomer has a melt index of less than 20 dg/min.

Additional features and advantages of the embodiments described herein will be set forth in the detailed description which follows, and in part will be readily apparent to those skilled in the art from that description or recognized by practicing the embodiments described, including the detailed description and the claims which are provided infra.

### BRIEF DESCRIPTION OF THE DRAWINGS

The following detailed description of specific embodiments of the present disclosure can be best understood when read in conjunction with the following drawings in which:

FIG. 1 is an illustration of a counter-rotating twin screw extruder, according to embodiments herein.

### DETAILED DESCRIPTION

Embodiments described herein relate to methods for producing an ionomer using a counter-rotating twin screw extruder.

Additional features and advantages of the described embodiments will be set forth in the detailed description, which follows, and in part will be readily apparent to those skilled in the art from that description or recognized by practicing the described embodiments, including the detailed description, which follows, as well as the claims.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Ethylene acid interpolymer” is a polymerized reaction product of at least ethylene and one or more unsaturated carboxylic acids, but also may refer to a polymerized reaction product of ethylene, one or more unsaturated carboxylic acids, and an additional monomer.

“Unsaturated carboxylic acids” may also be referred to herein as an ethylenically unsaturated carboxylic acid.

As used herein, “ionomer” is an ethylene acid interpolymer that is at least partially neutralized by metal cations.

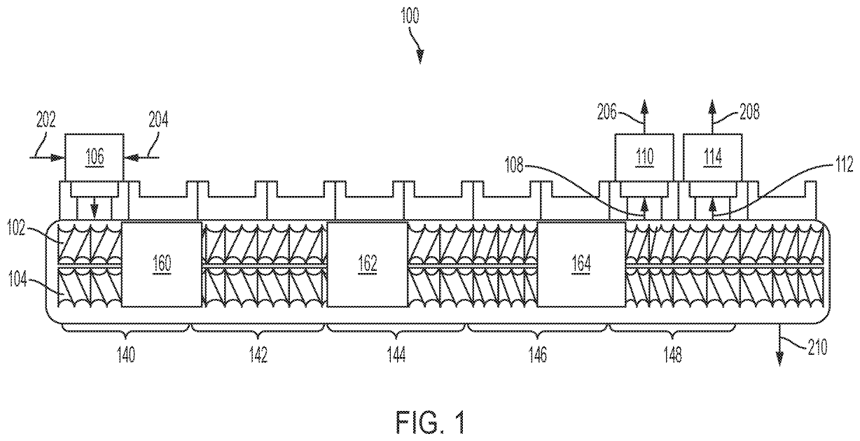

Referring initially to FIG. 1, illustrated is a representation of a counter-rotating twin screw extruder 100, used in embodiments of the method herein. The twin screw extruder 100 may include twin screws, represented by first screw 102 and second screw 104 and may be contained within a housing 120. The twin screw extruder 100 may also include one or more feed mixers 106. The one or more feed mixers 106 may be configured to feed an ethylene acid interpolymer stream 202, as well as a metal cation stream 204, into the twin screws. Water may also be fed into the twin screw extruder with the streams 202 and 204 (not shown). In embodiments, the water may be distilled water. The twin screws may then be capable of mixing the ethylene acid interpolymer stream 202, as well as the metal cation stream 204, along the length of the twin screws to produce an ionomer product stream 210.

The twin screw extruder may also include vent ports 108 and 112 for extracting first and second vent streams 206 and 208 from the twin screw extruder 100. The vent ports 108 and 112 may further include, respectively, vacuum pumps 110 and 114. The vent ports and vacuum pumps in combination may operate to control de-volatilization of the methods herein by removing water vapor and carbon dioxide created as a by-product of the formation of the ionomer product stream 210. In embodiments, the rough vacuum of the vacuum pumps may be from 10 inches of mercury (“Hg”) to approximately 30 Hg.

Still referring to FIG. 1, the twin screws may be tangentially oriented relative to each other. In other words, the twin screws may be non-intermeshing. It is contemplated that the twin screws being non-intermeshing, rather than intermeshing, may allow longer L/D ratios and higher volumes compatible with the methods herein. This may be due to the reduction of pressure build up in the formerly intermeshing regions of the twin screws. The reduction of pressure build up may also result in minimization of screw deflection and reduction in wearing of the twin screws. Accordingly, greater L/D ratios are possible with non-intermeshing counter-rotating twin screws.

As previously stated, the twin screws may rotate opposite one another. For example, and in embodiments, when looking at the face of the two screws in the twin screw extruder, both screws may rotate outwards or both the twin screws may rotate inwards. Rotating the twin screws opposite each other may further include rotating the twin screws at least 150 rotations per minute (RPMS). Rotating the twin screws may also occur at a RPM of from 100 to 800 rpm, from 100 to 550 rpm, from 100 to 450 rpm, from 100 to 345 rpm, from 100 to 250 rpm, or any combination of ranges, or smaller range, therein.

In embodiments, the twin screws may each further include a barrel, screw elements and one or more mixing elements. The screw elements may intake and convey material. The one or more mixing elements 160, 162, 164 may input energy into the material for melting and mixing as well as raising the material temperature for reaction. In this manner, the one or more mixing sections 160, 162, 164 may operate to mix the ethylene acid interpolymer stream 202 and the metal cation stream 204. The mixing elements may include, but may not be limited to: one or more kneading elements, one or more slotted screw elements (which may be left handed or right handed), one or more blister rings, one or more cylindrical mixing elements, one or more pineapple mixing elements, one or more diamond mixing elements, or combinations thereof.

The one or more mixing elements may be in contact with and extend from an outside surface of the barrel, which may also be referred to as a radial edge of the barrel (only separated by a clearance). In so having, the two screws in the twin screw extruder may each have an outer diameter and an inner diameter. The outer diameter may be measured from the radial center of the screw to the radial edge of the mixing elements (only separated by a clearance). The inner diameter may be measured from the radial center of the screw to the root of the screw. The outer diameter of a counter-rotating twin screw extruder may vary from 20 mm to 300 mm.

In embodiments, the twin screws may have a length to outer diameter ratio (L/D ratio) of at least 60. It is contemplated that a length to outer diameter ratio of at least 60 may be significant because that ratio may provide the necessary residence time and heat transfer between the interpolymers and the metal cations, thereby increasing the melt temperature of the extrusion process and completing the reaction. The twin screws may also have a length to outer diameter (L/D) ratio of from 60 to 120, from 60 to 110, from 60 to 100, from 60 to 90, from 60 to 80, from 60 to 70, or any combination of ranges, or smaller range, therein.

In embodiments the counter-rotating twin screw extruder 100 may be heated. The counter-rotating twin screw extruder 100 may be heated through the barrel, through the mixing elements, or both. The counter-rotating twin screw extruder 100 may be heated to a temperature of from 70 °C to 280 °C, from 150 °C to 280 °C, from 190 °C to 280 °C, from 220 °C to 280 °C, from 240 °C to 280 °C or any combination of ranges, or smaller range, therein. In embodiments, the temperature of the counter-rotating twin screw extruder may only be limited by the degradation temperature of the ethylene acid terpolymer.

The counter-rotating twin screw extruder may also include one or more zones. The one or more zones may each be heated at a different temperature, such that the contents within the extruder are heated at different temperatures within each of the one or more zones. Each subsequent zone may be at a greater temperature than the preceding zone. For example, and in embodiments, the one or more zones may include at least five zones. The first zone 140 may be heated at a temperature of from 10 °C to 280 °C. The second zone 142 may be heated at a temperature of from 70 °C to 280 °C. The third zone 144 may be heated at a temperature of from 150 °C to 280 °C. The fourth zone 146 may be heated at a temperature of from 190 °C to 280 °C. The fifth zone 148 may be heated at a temperature of from 220 °C to 240 °C or from 220 °C to 280 °C.

As previously stated, embodiments herein are directed to methods for producing an ionomer using a counter-rotating twin screw extruder. Any of the previously stated embodiments of the twin screw extruder 100 may be used in the methods hereinafter. The method initially includes feeding a one or more metal cations and an ethylene acid interpolymer into the counter-rotating twin screw extruder. The method further includes producing the ionomer by at least partially neutralizing the ethylene acid interpolymer with the one or more metal cations while twin screws of the counter-rotating twin screw extruder rotate opposite each other.

As previously mentioned, the ethylene acid interpolymer may include the polymerized reaction product of ethylene and unsaturated carboxylic acid. Also as previously mentioned, the ethylene acid interpolymer may further include another monomer. For example, and in embodiments, the further monomer may include but may not be limited to, acrylate, methacrylate ester, or both. Various unsaturated carboxylic acid containing comonomers may also be utilized in the ethylene acid interpolymers. For example, the unsaturated carboxylic acid containing comonomer may include a monocarboxylic acid, which may include acrylic acid, methacrylic acid, or both. In embodiments, The ethylene acid interpolymer may be the polymerized reaction product of 70 to 85 wt. % ethylene and 15 to 30 wt. % unsaturated carboxylic acids, based on the total weight of monomers present in the ethylene acid interpolymer. All individual values and ranges are included and disclosed herein. For example, in some embodiments, the ethylene acid interpolymer may be the polymerized reaction product of from 72 to 85 wt. % of ethylene; and from 15 to 28 wt. % unsaturated carboxylic acid, based on the total weight of monomers present in the ethylene acid interpolymer. In other embodiments, the ethylene acid interpolymer may be the polymerized reaction product of from 75 to 85 wt. % of ethylene; and from 15 to 25 wt. % of unsaturated carboxylic acid, based on the total weight of monomers present in the ethylene acid interpolymer. In further embodiments, the ethylene acid interpolymer may be the polymerized reaction product of from 79 to 82 wt. % of ethylene; and from 18 to 21 wt. % of unsaturated carboxylic acid, based on the total weight of monomers present in the ethylene acid interpolymer.

The ethylene acid interpolymer may be polymerized according to processes disclosed in U.S. Pat. Nos. 3,404,134; 5,028,674; 6,500,888; and 6,518,365. In some embodiments, blends of two or more ethylene acid interpolymers may be used, provided that the aggregate components and properties of the blend fall within the limits described above for the ethylene acid interpolymers.

Optionally, the ethylene acid interpolymer may be at least partially neutralized prior to feeding into the counter-rotating twin screw extruder. As used herein, neutralization is defined by percent neutralization of total acid units. Referring to the total acid units neutralized, the calculation of percent neutralization is based on the number of acid units considered to be present, based on the known amount of moles of the unsaturated carboxylic acid and the number of mole equivalents of the one or more metal cations added. In embodiments herein, from 0.01 mole % to 100 mole % of total acid units of the ethylene acid interpolymer neutralized by the one or more metal cations. All individual values and subranges are included and disclosed herein. In further embodiments, from 1 mole % to 95 mole %, from 10 mole % to 90 mole %, or from 50 mole % to 90 mole % of total acid units may be neutralized.

The ethylene acid interpolymer may have a melt index (I₂) of at least 50 decigrams per minute (dg/min) as determined according to ASTM D1238 (at 190 °C, 2.16 kg). Melt index may be commonly understood to be an indirect measurement of the molecular weight of the ethylene acid interpolymer. Greater melt indexes are indicative of low molecular weight, and vice versa. In embodiments, the ethylene acid interpolymer may also have a melt index of from 50 to 200, from 50 to 150, from 50 to 125, from 50 to 100, from 50 to 75, from 50 dg/min to 60 dg/min, or any combination of ranges, or smaller range, therein.

In the methods herein, the ionomer produced may have a melt index (I₂) of less than 20 dg/min. The ionomer produced may also have a melt index of from 1 to 20, from 1 to 18, from 1 to 12, from 1 to 8, from 1 to 4 dg/min, or any combination of ranges, or smaller range, therein. It is contemplated that achieving a melt index of less than 20 dg/min is desirable because melt indexes may also serve as a relative indicator of reaction completeness. For example, as reaction completeness increases, melt index is also observed to decrease. In commercial-scale automated production, melt index may accordingly serve as a quicker in-line measurement versus more time-consuming visual inspection for haziness.

In embodiments, the ionomer may have a haze of less than 20 percent. As previously stated, the haze of an ionomer is generally understood to represent the completeness of the chemical reaction forming the ionomer. As haziness, (the opaqueness) increases, the completeness of the ionomer forming chemical reaction is considered to decrease, and vice-versa. In embodiments the ionomer may have a haze of from 1 to 20, from 1 to 18, from 1 to 12, from 1 to 8, from 1 to 4, or any combination of ranges, or smaller range, therein.

As previously stated, the agent used to neutralize acid units of the ethylene acid interpolymer may include a metal cation or a combination of two or more metal cations. The one or more metal cations may include an alkaline earth metal. For example, and in embodiments, the one or more metal cations may include calcium, zinc, magnesium, or combinations thereof. In one embodiment, the one or more metal cations includes zinc. The one or more metal cations, such as zinc, may be suspended in an ethylene acid interpolymer as a masterbatch; however, various mechanisms for delivering one or more metal cations for neutralization are considered suitable. The acid interpolymer may be the ethylene acid interpolymer, or it may be a second ethylene acid interpolymer. The second ethylene acid interpolymer may have a melt index of at least 500 dg/min. The second ethylene acid interpolymer may have a melt index of from 500 to 3000, from 500 to 2500, from 500 to 2000, from 500 to 1500, or from 500 to 1000 dg/min, or any combination of ranges, or smaller range, therein.

As previously stated, the counter-rotating twin screw extruder may be heated. In embodiments wherein the extruder is heated, the one or more metal cations and the ethylene acid interpolymer may be heated within the twin screw extruder at a temperature of from 70 °C to 280 °C, or at any ranges of the temperatures previously discussed, whether in the twin screw extruder in general, or within the one or more zones of the twin screw extruder.

In embodiments, the method may further include extruding the ionomers into pellets. The extruding rate of the ionomer may be from 200 to 450 pounds per hour for a 50 mm tangential counter-rotating twin screw extruder. The extruding rate may also be from 200 to 450, from 200 to 400, from 200 to 350, from 200 to 300, from 200 to 250, or any combination of ranges, or smaller range, therein for a 50 mm tangential counter-rotating twin screw extruder. For counter-rotating twin screw extruders of other outer diameters a volumetric capacity may be defined which the ratio of the extruding rate of the ionomer to the cube of the outer diameter. Accordingly, the volumetric capacity of the counter-rotating twin screw extruder may be from 0.0014 lb/hr per mm³ to 0.0037 lb/hr per mm³. The volumetric capacity of the counter-rotating twin screw extruder may be from 0.001 to 0.0050, from 0.001 to 0.004, from 0.001 to 0.003, from 0.001 to 0.002 lb/hr per mm³, or any combinations of ranges, or smaller range, therein.

In embodiments, and as previously mentioned, the method may also include feeding the water or a metal salt solution (e.g. zinc acetate) into the counter-rotating twin screw extruder. The ionomer on one or more vent streams may then be produced by at least partially neutralizing the ethylene acid interpolymer with the one or more metal cations in the presence of the water while the twin screws of the counter-rotating twin screw extruder rotate opposite each other. The one or more vent streams may include water vapor, carbon dioxide, or both. The one or more vent streams may be extracted through one or more vent port of the counter-rotating twin screw extruder. The method of extraction may be through the vacuum pumps 110 and 114 through the vent ports 108 and 112, as previously mentioned.

### Test Methods

### Melt Index (I₂)

For ethylene-based polymers, melt index (I₂) was measured in accordance with ASTM D-1238, Procedure B (condition 190 °C/2.16 kg) and reported in decigrams eluted per 10 minutes (dg/min).

### Haze

Haze was measured in accordance with ASTM D1003. Haziness is ordinarily measured as the percentage of incident light scattered by more than 2.5 degrees through the ionomer. Haze was measured on compression molded 0.125″ plaques, molded at 190 °C using a Carver press and a plate mold with Mylar sheets inserts on either side.

### Moisture Content

Moisture Content was measured at 150 °C in accordance with ASTM D6869.

### Zinc Oxide Content

Energy Dispersive X-Ray Fluorescence (XRF) Spectrometry was performed for the detection of the total zinc content in the ionomer product. An Oxford Twin X benchtop analyzer was used. The following conditions were used for the measurement: 26 kV, 40 uA excitation, Z1 primary filter, no secondary filter, PIN detector, 8.44-8.82 kV ROI for zinc, 15-20 kV ROI for backscatter, 180 seconds analysis time, medium air. The measurement was conducted by first assembling a sample cup with a Chemplex 6 μm Mylar polyester x-ray film. The sample cup was then filled up to or just above the indicator line with ionomer pellets and capped. The cup was shaken to settle the pellets against the film and then loaded into the carousel of the instrument to run the analysis.

### EXAMPLES

Ionomer were formed according to the embodiments herein, and compared to ionomers formed using different parameters and types of extruders. The compositions of the components of the Ionomers used in the examples are shown below in Table 1. The metal cation was 45 wt. % zinc oxide suspended in an ethylene acid interpolymer carrier.

TABLE 1
Ionomer Compositions

| | | Ethylene Acid | | | |
|---|---|---|---|---|---|
| | Ethylene Acid | Interpolymer MI | % Ethylene | | |
| | Interpolymer | (2.16 kg, 190 °C), | Acid | % Metal | |
| Sample | Monomers | dg/min | Interpolymer | Cation (ZnO) | % Water |
| Ionomer 1 | 85 wt. % E + 15 | 60 | 95.7 | 2.9 | 1.5 |
| | wt. % MAA | | | | |
| Ionomer 2 | 81 wt. % E + 19 | 250 | 91.2 | 6.5 | 2.2 |
| | wt. % MAA | | | | |

The ethylene acid interpolymers were prepared by standard free-radical interpolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference. Additional aspects of the ionomer are provided below in Table 1. The ionomers of these acid interpolymers were prepared as stated above.

The ethylene acid interpolymer and the metal cation for each of the above ionomers were fed into a 2 inch (50.8 mm) outer diameter 83 L/D tangential counter-rotating twin screw extruder (from NFM Welding Engineers of Massillon, OH) using two K-Tron loss in weight feeders. The distilled water was fed into the twin screw extruder using a Milton Roy piston pump with dual head design. The twin screw extruder further included two vent ports, as well as a 20 horsepower Busch vacuum pump to de-volatilize the twin screw extruder. Pellets of the ionomer were discharged using a Gala divert valve and a Gala Model 6 underwater pelletizer. Pellets were discharged onto a cooler classifier to dry before being packaged and sealed in aluminum bags until testing. The twin screw extruder was also heated in five zones, according to embodiments herein. The zone temperatures are shown below in Table 2. Additional processing details are provided in Tables 3 and 4, for Ionomers 1 and 2, respectively. As shown in Tables 3 and 4, additional comparative samples were prepared, utilizing either a tandem single screw extruder or a co-rotating twin screw extruder with similar components to the tangential counter-rotating twin screw extruder.

TABLE 2
Extruder Zone Temperatures
Temperature (°C)

| Zone 1 | Zone 2 | Zone 3 | Zone 4 | Zone 5 |
|---|---|---|---|---|
| 16 | 80 | 160 | 200 | 230 |

TABLE 3
Processing Parameters for Ionomer 1 Examples

| | | | Extruder | | | Normalized | | Screw |
|---|---|---|---|---|---|---|---|---|
| | | | Outer | Extruder | Production | Product | Screw | Specific |
| | Extruder | | Diameter | L/D | Rate | Rate | Speed | Energy |
| Example | Type | Ionomer | mm | Ratio | lb/hr | lb/hr/mm³ | rpm | KWhr/kg |
| Inventive | Counter- | Ionomer | 50.8 | 83 | 225 | 0.0017 | 345 | 0.31 |
| Example 1 | rotating | 1 | | | | | | |
| Inventive | Counter- | Ionomer | 50.8 | 83 | 300 | 0.0023 | 530 | 0.34 |
| Example 2 | rotating | 1 | | | | | | |
| Inventive | Counter- | Ionomer | 50.8 | 83 | 410 | 0.0031 | 530 | 0.31 |
| Example 3 | rotating | 1 | | | | | | |
| Inventive | Counter- | Ionomer | 50.8 | 72 | 450 | 0.0034 | 530 | 0.24 |
| Example 4 | rotating | 1 | | | | | | |
| Comparative | Co-rotating | Ionomer | 42 | 48 | 150 | 0.002 | 250 | 0.22 |
| Example 1 | | 1 | | | | | | |
| Comparative | Co-rotating | Ionomer | 42 | 48 | 200 | 0.0027 | 450 | 0.25 |
| Example 2 | | 1 | | | | | | |

TABLE 4
Processing Parameters for Ionomer 2 Examples

| | | | Extruder | | | Normalized | | Screw |
|---|---|---|---|---|---|---|---|---|
| | | | Outer | Extruder | Production | Product | Screw | Specific |
| | Extruder | | Diameter | L/D | Rate | Rate | Speed | Energy |
| Example | Type | Ionomer | mm | Ratio | lb/hr | lb/hr/mm³ | rpm | KWhr/kg |
| Inventive | Counter- | Ionomer | 50.8 | 83 | 225 | 0.0017 | 345 | 0.3 |
| Example 5 | rotating | 2 | | | | | | |
| Inventive | Counter- | Ionomer | 50.8 | 83 | 340 | 0.0026 | 530 | 0.31 |
| Example 6 | rotating | 2 | | | | | | |
| Inventive | Counter- | Ionomer | 50.8 | 83 | 400 | 0.0031 | 530 | 0.26 |
| Example 7 | rotating | 2 | | | | | | |
| Inventive | Counter- | Ionomer | 50.8 | 83 | 450 | 0.0034 | 530 | 0.23 |
| Example 8 | rotating | 2 | | | | | | |
| Comparative | Counter- | Ionomer | 50.8 | 72 | 400 | 0.0031 | 530 | 0.24 |
| Example 9 | rotating | 2 | | | | | | |
| Comparative | Co-rotating | Ionomer | 42 | 48 | 150 | 0.002 | 450 | 0.31 |
| Example 3 | | 2 | | | | | | |
| Comparative | Co-rotating | Ionomer | 42 | 48 | 100 | 0.0013 | 450 | 0.4 |
| Example 4 | | 2 | | | | | | |

TABLE 5
Test Results for Ionomer 1 Examples

| | | | | Melt | | | | |
|---|---|---|---|---|---|---|---|---|
| | | | | Index at | Moisture | | | |
| | | | Extruder | 2.16 kg, | Content | | | |
| | Extruder | | L/D | 190 °C | at 150 °C | Zinc Oxide | | Plaque |
| Example | Type | Ionomer | Ratio | dg/min | ppm | wt. % | Haze | Appearance |
| Inventive | Counter- | Ionomer | 83 | 17.2 | 112 | 1.28 | 8.3 | Clear |
| Example 1 | rotating | 1 | | | | | | |
| Inventive | Counter- | Ionomer | 83 | 15.5 | 81 | 1.28 | 13.4 | Clear |
| Example 2 | rotating | 1 | | | | | | |
| Inventive | Counter- | Ionomer | 83 | 12.2 | 143 | 1.43 | 9.4 | Clear |
| Example 3 | rotating | 1 | | | | | | |
| Inventive | Counter- | Ionomer | 72 | 16.6 | 292 | 1.56 | 11.5 | Clear |
| Example 4 | rotating | 1 | | | | | | |
| Comparative | Co-rotating | Ionomer | 48 | 15.5 | 450 | 1.65 | 31.7 | Slightly |
| Example 1 | | 1 | | | | | | Hazy |
| Comparative | Co-rotating | Ionomer | 48 | 22.5 | 489 | 1.4 | 77.6 | Very Hazy |
| Example 2 | | 1 | | | | | | |

TABLE 6
Test Results for Ionomer 2 Examples

| | | | | Melt | | | | |
|---|---|---|---|---|---|---|---|---|
| | | | | Index at | Moisture | | | |
| | | | Extruder | 2.16 kg, | Content | | | |
| | Extruder | | L/D | 190 °C | at 150 °C | Zinc Oxide | | Plaque |
| Example | Type | Ionomer | Ratio | dg/min | ppm | wt. % | Haze | Appearance |
| Inventive | Counter- | Ionomer | 83 | 4.3 | 273 | 3.5 | 10.9 | Clear |
| Example 5 | rotating | 2 | | | | | | |
| Inventive | Counter- | Ionomer | 83 | 6.4 | 205 | 3.12 | 11.8 | Clear |
| Example 6 | rotating | 2 | | | | | | |
| Inventive | Counter- | Ionomer | 83 | 6.4 | 226 | 3.04 | 18.5 | Clear |
| Example 7 | rotating | 2 | | | | | | |
| Inventive | Counter- | Ionomer | 83 | 6.0 | 392 | 3.49 | 15.7 | Clear |
| Example 8 | rotating | 2 | | | | | | |
| Inventive | Counter- | Ionomer | 72 | 6.8 | 520 | 3.63 | 22.6 | Slightly |
| Example 9 | rotating | 2 | | | | | | Haze |
| Comparative | Co-rotating | Ionomer | 48 | 9.6 | 1533 | 3.71 | 86.7 | Hazy |
| Example 3 | | 2 | | | | | | |
| Comparative | Co-rotating | Ionomer | 48 | 9.2 | 1247 | 3.72 | 52.36 | Hazy |
| Example 4 | | 2 | | | | | | |

As shown in examples with Ionomer 1 and 2 in Tables 5 and 6, respectively, the tangential counter-rotating twin screw extruder with L/D of 72 & 83 produced ionomers with lower haze than equivalent ionomers produced by a co-rotating twin screw extruder with L/D 48. Specifically, all of the counter-rotating twin screw extruders yielded a haze value less than 20% and a clear plaque appearance. The counter-rotating twin screw extruders, on average, also resulted in ionomers with lower melt indexes than for the comparative examples. The lower melt indexes in Tables 5 and 6 were also lower than that for the respective base resins, indicative of reaction and ionomer formation. Further yet, the counter-rotating twin screw extruders, on average, also resulted in ionomers with lower moisture contents than for the comparative examples.

The embodiments herein may include one or more aspects. According to a first aspect, a method for producing an ionomer using a counter-rotating twin screw extruder includes feeding one or more metal cations and an ethylene acid interpolymer into the counter-rotating twin screw extruder, the ethylene acid interpolymer including the polymerized reaction product of ethylene and unsaturated carboxylic acid; and producing the ionomer by at least partially neutralizing the ethylene acid interpolymer with the one or more metal cations while twin screws of the counter-rotating twin screw extruder rotate opposite each other, and wherein: the twin screws have a length to diameter ratio of at least 60; a normalized production rate of the twin screw extruder is from 0.0014 lb/hr per mm³ to 0.0037 lb/hr per mm³; the ethylene acid interpolymer has a melt index (I₂) of at least 50 dg/min, and the ionomer has a melt index of less than 20 dg/min.

A second aspect includes any preceding aspect, and may further include extruding the ionomer into pellets.

A third aspect includes any preceding aspect, wherein the ionomer has a haze of less than 20 percent.

A fourth aspect includes any preceding aspect, wherein the one or more metal cations includes alkaline earth metal.

A fifth aspect includes any preceding aspect, wherein the ethylene acid interpolymer includes a interpolymer of ethylene and (meth)acrylic acid.

A sixth aspect includes any preceding aspect, wherein the one or more metal cations include zinc.

A seventh aspect includes any preceding aspect, wherein the zinc is suspended in a second ethylene acid interpolymer with a I₂ of at least 500 dg/min.

An eighth aspect includes any preceding aspect, wherein the two screws in the counter-rotating twin screw extruder are tangentially oriented relative to each other.

A ninth aspect includes any preceding aspect, wherein the ethylene acid interpolymer is an ionomer at least partially neutralized prior to feeding.

A tenth aspect includes any preceding aspect, wherein the one or more metal cations and the ethylene acid interpolymer within the counter-rotating twin screw extruder are heated at a temperature of from 70 °C to 280 °C.

An eleventh aspect includes any preceding aspect, wherein the counter-rotating twin screw extruder has five separate zones, wherein: the first zone is at a temperature of from 10 to 280 °C; the second zone is at a temperature of from 70 to 280 °C; the third zone is at a temperature of from 150 to 280 °C; the fourth zone is at a temperature of from 190 to 280 °C; and the fifth zone is at a temperature of from 220 to 280 °C.

An twelfth aspect includes the tenth aspect, wherein each subsequent zone is at a greater temperature than the preceding zone.

A thirteenth aspect includes any preceding aspect, wherein rotating the twin screws opposite each other further includes rotating the twin screws at from 150 to 800 rotations per minute (RPMs).

A fourteenth aspect includes any preceding aspect, wherein an extruding rate of the ionomer is from 200 to 450 pounds per hour.

A fifteenth aspect includes any preceding aspect, and further includes feeding water into the counter-rotating twin screw extruder; producing the ionomer and one or more vent streams by at least partially neutralizing the ethylene acid interpolymer with the one or more metal cations in the presence of the water while the twin screws of the counter-rotating twin screw extruder rotate opposite each other; and extracting the one or more vent streams through one or more vent ports of the counter-rotating twin screw extruder, the one or more vent streams including water vapor and carbon dioxide.

It is noted that recitations in the present disclosure of a component of the present disclosure being “operable” or “sufficient” in a particular way, to embody a particular property, or to function in a particular manner, are structural recitations, as opposed to recitations of intended use. More specifically, the references in the present disclosure to the manner in which a component is “operable” or “sufficient” denotes an existing physical condition of the component and, as such, is to be taken as a definite recitation of the structural characteristics of the component.

The singular forms “a,” “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned.

As used in this disclosure and in the appended claims, the words “comprise,” “has,” and “include” and all grammatical variations thereof are each intended to have an open, non-limiting meaning that does not exclude additional elements or steps.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

Having described the subject matter of the present disclosure in detail and by reference to specific embodiments, it is noted that the various details disclosed in the present disclosure should not be taken to imply that these details relate to elements that are essential components of the various embodiments described in the present disclosure. Further, it will be apparent that modifications and variations are possible without departing from the scope of the present disclosure, including, but not limited to, embodiments defined in the appended claims.

1. A method for producing an ionomer using a counter-rotating twin screw extruder, the method comprising:
feeding one or more metal cations and an ethylene acid interpolymer into the counter-rotating twin screw extruder, the ethylene acid interpolymer comprising the polymerized reaction product of ethylene and unsaturated carboxylic acid; and
producing the ionomer by at least partially neutralizing the ethylene acid interpolymer with the one or more metal cations while twin screws of the counter-rotating twin screw extruder rotate opposite each other, and wherein:
the twin screws have a length to diameter ratio of at least 60;
a normalized production rate of the twin screw extruder is from 0.0014 lb/hr per mm³ to 0.0037 lb/hr per mm³;
the ethylene acid interpolymer has a melt index (I₂) of at least 50 dg/min, and
the ionomer has a melt index of less than 20 dg/min.

2. The method of claim 1, further comprising extruding the ionomer into pellets.

3. The method of claim 1, wherein the ionomer has a haze of less than 20 percent.

4. The method of claim 1, wherein the one or more metal cations comprise alkaline earth metals.

5. The method of claim 1, wherein the ethylene acid interpolymer comprises an interpolymer of ethylene and (meth)acrylic acid.

6. The method of claim 1, wherein the one or more metal cations comprise zinc.

7. The method of claim 6, wherein the zinc is suspended in a second ethylene acid interpolymer, the second ethylene acid interpolymer comprising a I₂ of at least 500 dg/min.

8. The method of claim 1, wherein the two screws in the counter-rotating twin screw extruder are tangentially oriented relative to each other.

9. The method of claim 1, wherein the ethylene acid interpolymer is an ionomer that is at least partially neutralized prior to the feeding step.

10. The method of claim 1, wherein the one or more metal cations and the ethylene acid interpolymer are heated at a temperature of from 70 °C to 280 °C within the counter-rotating twin screw extruder.

11. The method of claim 1, wherein the counter-rotating twin screw extruder comprises five separate zones, wherein:
the first zone is at a temperature of from 10 to 280 °C;
the second zone is at a temperature of from 70 to 280 °C;
the third zone is at a temperature of from 150 to 280 °C;
the fourth zone is at a temperature of from 190 to 280 °C; and
the fifth zone is at a temperature of from 220 to 280 °C.

12. The method of claim 10, wherein each subsequent zone of the five separate zones is at a greater temperature than the preceding zone.

13. The method of claim 1, wherein rotating the twin screws opposite each other further comprises rotating the twin screws at from 150 to 800 rotations per minute (RPMs).

14. The method of claim 1, wherein an extruding rate of the ionomer is from 200 to 450 pounds per hour.

15. The method of claim 1, further comprising:
feeding water into the counter-rotating twin screw extruder;
producing the ionomer and one or more vent streams by at least partially neutralizing the ethylene acid interpolymer with the one or more metal cations in the presence of the water while the twin screws of the counter-rotating twin screw extruder rotate opposite each other; and
extracting the one or more vent streams through one or more vent ports of the counter-rotating twin screw extruder, the one or more vent streams comprising water vapor and carbon dioxide.
